(19) United States
(12) Patent Application Publication
(10) Pub. No.: US 2022/0277162 A1
(43) Pub. Date: Sep. 1, 2022

(54) OPTICAL PERSON RECOGNITION TECHNIQUES FOR SOCIAL DISTANCING

(71) Applicant: Kogniz, Inc., Mill Valley, CA (US)

(72) Inventors: Jed Putterman, Mill Valley, CA (US); Daniel Putterman, Mill Valley, CA (US); Bill Klein, Montreal (CA)

(21) Appl. No.: 17/187,306

(22) Filed: Feb. 26, 2021

(51) Int. Cl. G06K 9/00; G06N 3/04; G01J 5/00; G06T 7/246

(52) U.S. Cl. CPC G06K 9/00778; G06K 9/00342; G06K 9/00295; G06N 3/0454; G01J 5/0025; G06T 7/251; G06T 2207/30232; G01J 2005/0077

(57) ABSTRACT

Methods, systems, and devices for data processing and artificial intelligence (AI) techniques are described. A system may support person detection using an optical camera. For example, the optical camera may detect motion and the system may implement a neural network to determine if the motion corresponds to a person's body. If the system detects a person, the system may assign a tracker identifier (ID) to the person's body and convert the position of the body in the view of the camera to a position in a horizontal plane. Based on the horizontal view, the system may spatially track the person in an environment, including determining if the person interacts with other people within a threshold distance, whether there are any congestion points in the environment, or both. The system may trigger alert procedures based on the interactions, congestion points, temperature readings for one or more people, or any combination thereof.

### FIELD OF TECHNOLOGY

The present disclosure relates generally to data processing and artificial intelligence (AI) systems, and more specifically to optical person recognition techniques for social distancing.

### BACKGROUND

Some environments—such as office buildings, stores, schools, or other environments—implement social distancing guidelines to mitigate the spread of diseases. For example, an environment may instruct people within the environment to maintain six feet of distance between one another to reduce the spread of an infectious disease. However, tracking whether people are following such social distancing guidelines and identifying people who break social distancing rules may raise a number of challenges. For example, based on privacy laws, an organization managing the environment may not be allowed to track people within the environment using devices carried by the people. Furthermore, based on the layout of the environment, people may frequently fail to maintain social distancing at specific areas of the environment (e.g., at intersections of hallways, entering or exiting rooms, etc.). Such challenges may lead to the spread of infectious diseases within the environment despite the intended social distancing guidelines.

### BRIEF DESCRIPTION OF THE DRAWINGS

FIG. 1 illustrates an example of a system for person detection and tracking that supports optical person recognition techniques for social distancing in accordance with aspects of the present disclosure.

FIGS. 2A and 2B illustrate examples of person tracking in a horizontal plane that supports optical person recognition techniques for social distancing in accordance with aspects of the present disclosure.

FIG. 3 illustrates an example of a process flow that supports optical person recognition techniques for social distancing in accordance with aspects of the present disclosure.

FIG. 4 shows a block diagram of an apparatus that supports optical person recognition techniques for social distancing in accordance with aspects of the present disclosure.

FIG. 5 shows a block diagram of a detection and tracking manager that supports optical person recognition techniques for social distancing in accordance with aspects of the present disclosure.

FIG. 6 shows a diagram of a system including a device that supports optical person recognition techniques for social distancing in accordance with aspects of the present disclosure.

FIGS. 7 through 10 show flowcharts illustrating methods that support optical person recognition techniques for social distancing in accordance with aspects of the present disclosure.

### DETAILED DESCRIPTION

Some environments may implement social distancing guidelines, for example, to mitigate the spread of diseases. Social distancing guidelines may define a threshold distance people are to maintain between one another. For example, an organization or law may instruct people within an environment to maintain six feet of distance between one another to reduce the spread of an infectious disease. However, tracking whether people are following such social distancing guidelines and identifying people who break social distancing rules may raise a number of challenges. For example, based on privacy laws, an organization managing the environment may not be allowed to track people within the environment using devices carried by the people. Additionally, people may accidentally or intentionally fail to report instances in which social distancing guidelines are not followed. Further, based on the layout of the environment, people may frequently fail to maintain social distancing at specific areas of the environment (e.g., at intersections of hallways, entering or exiting rooms, etc.). Such challenges may lead to the spread of infectious diseases within the environment despite the intended social distancing guidelines.

To support adherence to social distancing guidelines, a system may implement person detection and position tracking techniques. The system may store positioning information, trigger alerts, and provide analyses to support contact tracing, recommend traffic flows to reduce instances of people failing to adhere to social distancing guidelines, or both. For example, the system may support person detection using an optical camera. The optical camera may detect motion and the system may implement a neural network to determine if the motion corresponds to a person's body. If the system detects a person, the system may assign a tracker identifier (ID) to the person's body and convert the position of the body in the view of the camera to a position in a horizontal plane. Based on the horizontal view, the system may spatially track the person in an environment, including determining if the person interacts with other people within a threshold distance (e.g., within a six-foot social distancing threshold), whether there are any congestion points in the environment, or both. The system may trigger alert procedures based on the interactions, congestion points, temperature readings for one or more people, or any combination thereof.

In some cases, the system may support a user interface. The user interface may display a view of the people within the environment, for example, using the determined positionings within the horizontal plane. In some examples, the user interface may display additional information related to the people. For example, the user interface may display a circle of a threshold radius around each person, and the system may trigger an alert procedure if one person enters the circle of another person. In some cases, a user may define one or more alert triggers using the user interface. For example, the system may trigger an alert based on detecting people moving within a threshold distance of one another (e.g., where the threshold distance may be user-defined), based on detecting a person not wearing a face mask, based on a person failing to follow a traffic pattern within the environment, or based on any other trigger. Additionally or alternatively, the user may indicate an area of interest within the environment using the user interface. In some examples, the system may determine a recommended traffic pattern for the environment to improve adherence to the social distancing guidelines while optimizing access to the indicated area of interest. The user interface may be configurable to a specific organization, environment, or social distancing scenario.

Aspects of the disclosure are initially described in the context of a system for person detection and tracking. Additional aspects of the disclosure are described with reference to tracking procedures in a horizontal plane to support social distancing and a process flow. Aspects of the disclosure are further illustrated by and described with reference to apparatus diagrams, system diagrams, and flowcharts that relate to optical person recognition techniques for social distancing.

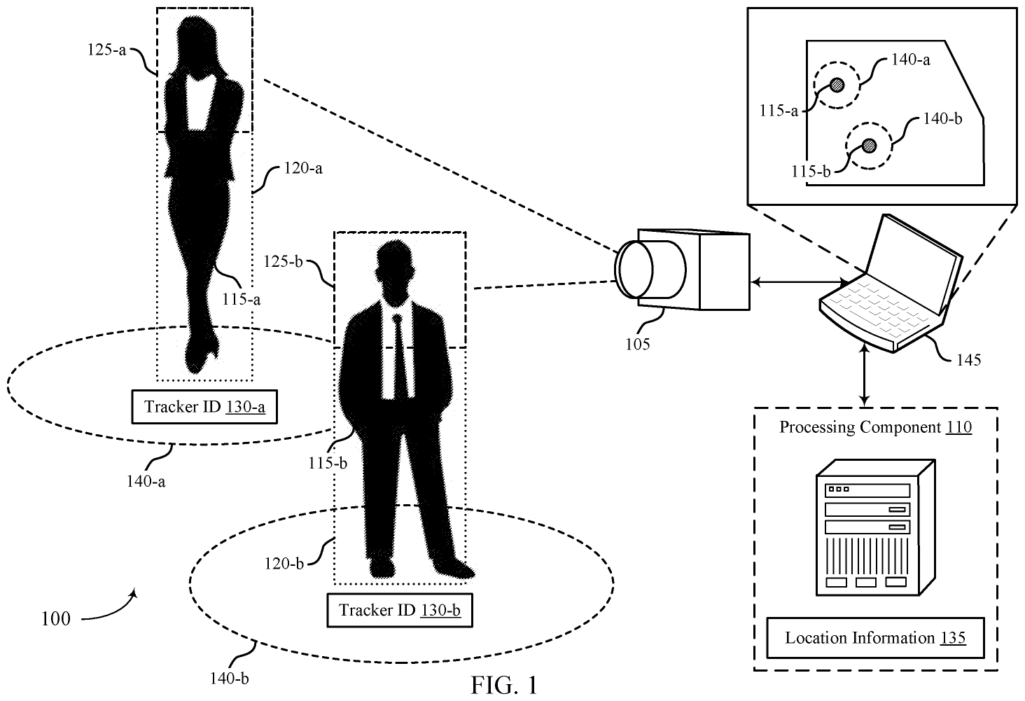

FIG. 1 illustrates an example of a system 100 for person detection and tracking that supports optical person recognition techniques for social distancing in accordance with aspects of the present disclosure. The system 100 may support person detection for an environment using an optical camera 105, which may be connected to a device 145 (e.g., a user device or backend device). The optical camera 105, the device 145, or some combination thereof may be connected to or otherwise include a processing component 110. The processing component 110 may support storing location information 135 locally at the device 145, at a database system, in cloud-based storage, or in any other storage mechanism. In some cases, the optical camera 105 may include or be connected to a thermal sensor for temperature detection. The optical camera 105 may support detecting a person 115 in the environment and tracking location information 135 for the person 115 according to a tracker ID 130. The optical camera 105, the device 145, the processing component 110, or a combination thereof may perform one or more conversions to translate positioning information for the detected people into a horizontal plane to determine whether a person 115-a is within a threshold distance from another person 115-b (e.g., to support social distancing guidelines).

The system 100 may implement an optical camera 105 to recognize people within an environment (e.g., a building, a room of a building, etc.). The optical camera 105 may be an example of a red, green, and blue (RGB) image sensor and may capture a video of the environment (e.g., an entrance to a building). To reduce the processing involved in detecting a person's face, the optical camera 105 may first detect a body and may detect a face based on the detected body. In this way, the optical camera 105 may refrain from searching for a small image (e.g., a face) in a large image (e.g., the full view of the optical camera 105). Instead, the optical camera 105 may detect motion between frames in the video stream to determine if a body may be present in the view of the optical camera 105. For example, the optical camera 105, the processing component 110, or a combination thereof may process the video stream from the optical camera 105 to analyze the video frame-by-frame (e.g., by decoding the video stream, for example, for an H.264 video stream or an H.265 video stream, or by receiving the frames directly). The processing component 110 may implement a neural network (e.g., a recurrent neural network (RNN)) or another technique to identify state changes across frames (e.g., consecutive frames, periodic frames). Based on the state changes, the optical camera 105 may detect motion and determine if the motion corresponds to a person's body, for example, using another neural network.

The optical camera 105 may detect multiple bodies in a frame and may track the bodies across a set of frames (e.g., using one or more RNNs) according to multiple trackers associated with respective tracker IDs 130. The system 100 (e.g., the optical camera 105, the processing component 110, or both) may assign a unique tracker ID 130 to each body detected in the frame. In some examples, the system 100 may use the tracker IDs 130 to track a person throughout an environment including multiple optical cameras 105. For example, the system 100 may track a person 115 exiting the view of a first optical camera 105 and entering the view of a second optical camera 105. Both optical cameras 105 may send information to the processing component 110, and the processing component 110 may determine that the person 115 in the view of each of the cameras is the same person corresponding to the same tracker ID 130. Accordingly, the system 100 may track a person 115 throughout an environment and maintain contact tracing information for the person 115, even if no single camera captures the entire environment within its view. In some examples, the processing component 110 may maintain a tracker in memory for a threshold amount of time after the body is not detected in case the body is detected again (e.g., if a person quickly reenters the view of an optical camera 105, if the person is temporarily obscured from an optical camera 105, if an optical camera 105 fails to detect the person for a few frames). In this way, the processing component 110 may not assign a new tracker ID 130 to a person who already corresponds to a recently tracked tracker ID 130.

If the optical camera 105 detects a person 115, the system 100 (e.g., the optical camera 105, the processing component 110, or both) may determine a first set of pixels 120 approximately corresponding to the person's body. The system 100 may use the first set of pixels 120 to simplify the facial detection procedure by limiting the area in which to search for a face to a second set of pixels 125. The second set of pixels 125 may be based on the first set of pixels 120. For example, the second set of pixels 125 may correspond to the upper third of the first set of pixels 120. The system 100 may use a neural network (e.g., a convolutional neural network, such as an 18-layer model) to detect a face in the second set of pixels 125 corresponding to the upper third of an already detected body. The neural network may be trained on data based on searching in a specific area for a face (e.g., the top-third area of a person 115 detection box). In some examples, the system 100 may implement a first detection phase to detect a face in the environment and may implement a second classification phase to classify one or more aspects of the face (e.g., whether the face is wearing glasses, a hat, a mask, or corresponds to another classification). The processing component 110 may store the classification information in memory with an association to the corresponding tracker ID 130. In some cases, the classification information may be used to trigger one or more alerts (e.g., if a person 115 is not wearing a face mask).

In some cases, the system 100 may support facial recognition techniques. For example, the processing component 110 may compare one or more images of a face captured by the optical camera 105 to a set of images in a database, a set of images on the Internet, or some combination thereof. For example, if the system 100 corresponds to an office building, an organization running the office may maintain a catalog of employees in a database system. The processing component 110 may compare an image of a face to headshots of the employees stored in the database system (e.g., using a neural network or other algorithm). If the processing component 110 determines a match, the processing component 110 may retrieve additional information (e.g., a user ID, contact information, or other user information) associated with the person from the database and store the additional information with an association to the tracker ID 130.

In some examples, the system 100 may implement a thermal sensor to determine temperature information for a detected face. In some cases, the system 100 may align the thermal sensor with the optical camera 105 to determine a combined thermal image (e.g., where thermal information is overlaid over an RGB image of an RGB camera). Aligning the thermal sensor with the optical camera 105 may involve determining a distance from the optical camera 105 to the detected face, performing multiple distance measurements, temperature measurements, or both, and determining a pixel alignment between the thermal sensor and the optical camera 105. As such, the system 100 (e.g., the processing component 110) may determine one or more thermal pixels for the thermal sensor that are equivalent to one or more RGB pixels from the detected face for the optical camera 105.

The thermal sensor may obtain one or more temperature readings for the determined thermal pixels. In some cases, the thermal sensor, processing component 110, or both may determine a representative temperature for a person 115 from the thermal readings. The representative temperature may be an average temperature, a highest, non-outlier temperature reading, a temperature reading associated with a specific area of the face (e.g., around the eyes, under the nose, or some other area of the face), or any other temperature determined by the system 100. The system 100 may use the tracker IDs 130 to manage temperature information for multiple people in the environment. For example, the processing component 110 may store the representative temperature for a person 115 in memory with an association to the corresponding tracker ID 130. In some cases, the temperature information may be used to trigger one or more alerts (e.g., if the representative temperature for a person 115 satisfies a temperature threshold, such as a fever threshold).

Some other systems may determine temperature information without facial detection. For example, a system may require a person to position their face in a specific view of a thermal sensor in order for the sensor to determine a temperature reading for the person's face. Alternatively, some systems may use contour-based detection to determine an edge of motion in a video stream and perform temperature readings based on the identified contour.

In contrast, the system 100 may use a set of neural networks to detect a person's body, detect the person's face, and detect areas of the person's face supporting accurate temperature measurements. Each neural network may be trained offline using sets of training images, user confirmation, user feedback, or some combination thereof. In some cases, a neural network may be additionally trained online such that the neural network continues to improve the accuracy of person detection, facial detection, temperature readings, or some combination thereof.

As illustrated in FIG. 1, the optical camera 105 may detect movement within the view of the optical camera 105. The optical camera 105, the processing component 110, or both may detect a first set of pixels 120-a including detected motion and a first set of pixels 120-b including detected motion. The optical camera 105 may input the first set of pixels 120-a for one or more frames into a first neural network, and the first neural network may output an indication of whether the first set of pixels 120-a includes the body of a person 115-a. Similarly, the optical camera 105 may input the first set of pixels 120-b for one or more frames into the first neural network to determine whether the first set of pixels 120-b includes the body of a person 115-b.

The optical camera 105, processing component 110, or both may determine a second set of pixels 125-a associated with the first set of pixels 120-a and a second set of pixels 125-b associated with the first set of pixels 120-b. The determination of the subset of pixels may be based on a predicted positioning of a person's head relative to the body detected by the first neural network. The optical camera 105 may input the second set of pixels 125-a for one or more frames into a second neural network, and the second neural network may output an indication of the pixels corresponding to the person's face. The second neural network, or one or more additional neural networks, may further determine information associated with the face. For example, a neural network may output pixels corresponding to specific features of the face (e.g., for improved temperature readings), an indication of whether the face is turned or obscured in any way, or any other characteristics of the face. Similarly, the optical camera 105 may input the second set of pixels 125-b for one or more frames into the second neural network to determine the pixels of the second set of pixels 125-b corresponding to the second person's face.

The processing component 110 may store location information 135 for the person 115-a and the person 115-b. For example, the processing component 110 may generate and store a tracker ID 130-a for the person 115-a (e.g., in response to detecting the person 115-a) and may generate and store a tracker ID 130-b for the person 115-b. Additionally, the processing component 110 may store location information 135 associated with each tracker ID 130. For example, the optical camera 105, the processing component 110, or both may detect a geographic area where each detected person 115 is located. In some examples, the system 100 may use a hardware component, such as a stereoscopic sensor or other sensor, to detect the distance from the sensor to the person 115. In some cases, the optical camera 105 may include a stereoscopic sensor. In some other examples, the system 100 may use a software component to calculate the distance from the optical camera 105 to the person 115. For example, the optical camera 105, processing component 110, or both may compare a bounding box size associated with a person's body, a person's face, or both to estimate the distance from the optical camera 105 to the person 115. The location information 135 may include a person's distance from the optical camera 105, a direction of motion for a person 115, physical coordinates for a person 115, an amount of time spent at each location, an amount of time moving in a specific direction, or any combination thereof.

In some cases, the processing component 110 may dynamically update the storage granularity for the location information 135 based on a person's movement. For example, if a person 115 is moving at less than a threshold rate, the processing component 110 may reduce the granularity of storing the location information 135. Alternatively, if the person 115 is moving greater than a threshold rate, the processing component 110 may increase the granularity of storing the location information 135. In this way, if a person 115 sits at a desk for an hour, the processing component 110 may reduce the storage overhead associated with tracking position information for the person 115 by reducing the granularity of the stored information (e.g., storing location information on the scale of seconds or minutes). Alternatively, if the person 115 is actively walking through the environment, the processing component 110 may support real-time position tracking by increasing the granularity of the position measurements.

The processing component 110 may use homography techniques to create a two-dimensional, top-down view of the environment. For example, the processing component 110 may store multiple dimensions of the environment from the view of the optical camera 105. In some examples, the processing component 110 may automatically determine the dimension measurements using one or more sensors, pixel characteristics for the optical camera 105, or a combination thereof. In some other examples, a user may input the dimension measurements, for example, using a user interface. The user interface may display the camera view and the user may define dimensions for one or more objects displayed in the camera view. With at least two measurements corresponding to at least two different dimensions, the system 100 may convert from the two-dimensional camera view to the two-dimensional, top-down (e.g., bird's-eye) view. For example, the processing component 110 may perform a non-linear matrix calculation to convert from the two-dimensional camera view to a three-dimensional space (or matrix) and further to the two-dimensional, top-down view.

Using the conversion, the processing component 110 may convert location information 135 for a person 115 from relative to the camera's view to relative within a horizontal plane. Additionally, the processing component 110 may determine—or a user may define—objects or features within the environment. Such objects or features may be defined or converted to the top-down view. This information may support the processing component in determining a top-down view of the environment, including positioning of the trackers in real-time and how the trackers relate to other aspects of the environment. In some cases, the processing component 110 may surface this information to a display of a device 145. For example, the processing component 110 may send information defining aspects of the environment (e.g., a floor plane, relatively static objects with the environment, etc.) to the device 145. Additionally, the processing component 110 may send, using real-time or pseudo-real-time updates, location information 135 for the people to the device 145 to display in a user interface. The device 145 may display a position of the person 115-a and a position of the person 115-b within the environment (e.g., from a top-down view). Accordingly, the device 145 may support a normalized grid in which the locations of the people can be tracked (e.g., in real-time based on one or more optical cameras 105 and one or more transformation functions).

The location information 135 may further support tracking of information specific to social distancing. For example, the processing component 110 may determine circles 140 (or bubbles) around the identified people based on a threshold distance. For example, the processing component 110 may define a circle 140 around each person 115 with a radius or diameter equal to a threshold distance (e.g., for social distancing). As illustrated, the processing component 110 may track a circle 140-a for the person 115-a and may track a circle 140-b for the person 115-b. If the radius of the circle is set to the distance threshold, the optical camera 105, the processing component 110, the device 145, or some combination thereof may trigger an alert if a person 115 enters the circle 140 for another person 115. If the diameter of the circle is set to the distance threshold, the optical camera 105, the processing component 110, the device 145, or some combination thereof may trigger an alert if the circle 140 for one person 115 overlaps with the circle 140 for another person 115.

The system 100 may support a number of alert procedures. In some cases, a user may define one or more alert procedures, including triggers and alert formats. In a first example, the device 145 may display alert information. For example, if two people are within a threshold distance from one another (e.g., six-feet, or another threshold for social distancing), the device 145 may display an indication of the people failing to adhere to the threshold distance. The circles 140 may be displayed as green circles when social distancing is being followed. If the person 115-a and the person 115-b move within the threshold distance of one another, the circle 140-a and the circle 140-b may turn red to indicate the failure to follow proper social distancing. In some cases, the user interface of the device 145 may be displayed in such a way that the people may see the circles 140 turn red. Additionally or alternatively, a security administrator may see the circles 140 turn red. Additionally or alternatively, other indications (e.g., auditory, tactile, etc.) may be used to alert people of a failure to follow proper social distancing. Additionally or alternatively, the processing component may store a log in memory of encounters between people. The log may be used for contact tracing and may store timestamps, tracker IDs 130, and other information relevant to encounters where people failed to properly social distance (e.g., according to a distance threshold).

Other alert procedures may involve sending a short message service (SMS) text message to a user, sending a mobile push alert to a user, sending an email message to a user, or any other form of communication to alert a user based on a trigger condition being met. In some cases, an alert may be triggered based on temperature detection, positioning, or both. For example, the processing component 110 may trigger a first alert if a person is detected with a temperature satisfying a threshold temperature (e.g., a fever temperature). In some cases, such an alert may occur when a person 115 first enters an environment, and the alert may indicate for the person 115 to leave the environment or wait to get the temperature re-tested after a threshold period of time. Additionally or alternatively, the processing component 110 may trigger a second alert if people are within a threshold distance of one another. However, the processing component 110 may trigger a third alert (e.g., a high-priority alert) if a person 115 with a detected temperature satisfying the temperature threshold is within a threshold distance of another person 115.

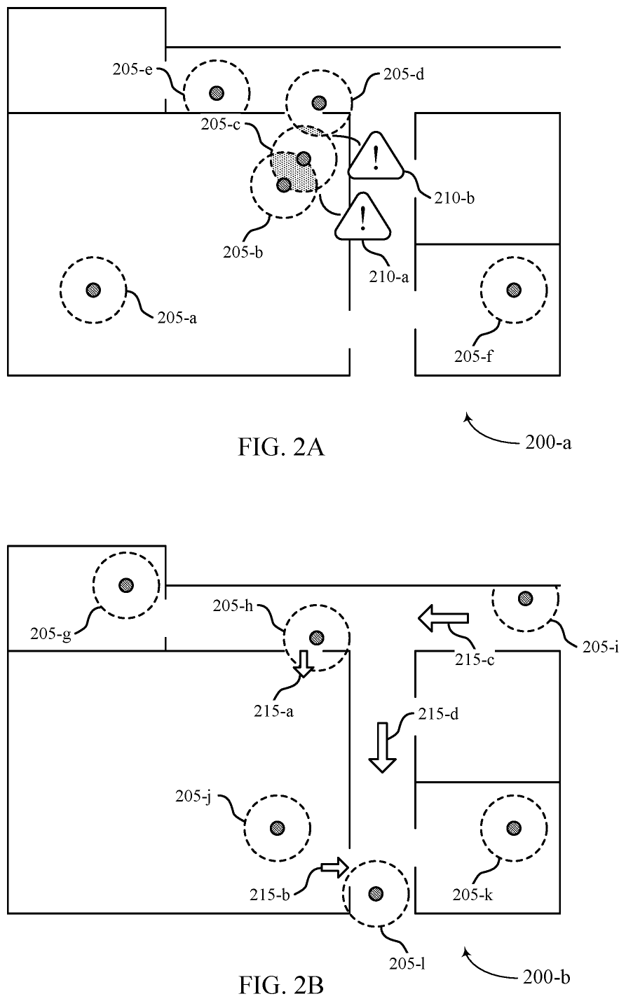

FIGS. 2A and 2B illustrate examples of person tracking 200 in a horizontal plane that supports optical person recognition techniques for social distancing in accordance with aspects of the present disclosure. The person tracking 200 in the horizontal plane may be determined based on measurements by an optical camera 105, information processing and coordinate transformation by a processing component 110, or both as described with reference to FIG. 1. In some cases, a device 145 (e.g., a smart phone, a laptop, a desktop computer, a screen, or another other device capable of displaying an image) may display the person tracking 200 in the horizontal plane. Additionally or alternatively, a memory system, database, or both may store information related to the person tracking 200 in the horizontal plane, such that the information may be played back, analyzed, audited, or some combination thereof.

FIG. 2A illustrates an example of person tracking 200-a in a horizontal plane including alert indications based on people failing to adhere to social distancing guidelines (e.g., failing to maintain a threshold distance between people). As illustrated, a system may store a floorplan for an environment, for example, based on optical camera images, sensor measurements, user-defined floorplans, or any combination thereof. The system (e.g., a system or device supporting processing of data) may track people as the people move through the environment. Each person may be represented by a tracker 205 with a circle, the circle based on a threshold distance (e.g., the threshold distance defined by social distancing guidelines). The system may trigger an alert 210 based on the locations of the trackers 205 in the environment.

If the circle for each tracker 205 has a radius equal to the threshold distance, the system may trigger an alert 210 if one tracker 205 enters the circle of another tracker 205. For example, the tracker 205-c may enter the circle for the tracker 205-b, triggering an alert 210-a. The alert 210-a may be a visual alert (e.g., as illustrated in FIG. 2A), an auditory alert, a tactile alert, or any other form of alert. Additionally or alternatively, the system may store a log entry based on the alert 210-a. For example, the system may store an indication that the person corresponding to tracker 205-c came into contact with the person corresponding to tracker 205-b (e.g., based on the defined threshold distance). The log entry may further include other relevant information, such as temperature readings for the trackers 205, images of the people, contact information for the people, a timestamp of the encounter, a duration of the encounter, or any other relevant information.

If the circle for each tracker 205 has a diameter equal to the threshold distance, the system may trigger an alert 210 if the circle for one tracker 205 overlaps the circle for another tracker 205. For example, the circle for the tracker 205-d may enter the circle for the tracker 205-c, triggering an alert 210-b. The alert 210-b may include any alert format as described herein. In some cases, obstacles may affect the circles for the trackers 205. For example, the circle for tracker 205-e may not pass through a wall (e.g., because the wall may effectively maintain peoples' physical distance). Additionally, the system may track peoples' locations and movements throughout a number of rooms, hallways, or other locations using a set of multiple cameras, sensors, or both communicating with shared processing components. For example, the system may track the position of tracker 205-a relative to tracker 205-f, even if no camera or sensor can detect both tracker 205-a and 205-f. The positions and movements of the trackers 205 may be determined using one or more measurement techniques, sensing techniques, coordinate conversion techniques, or any combination thereof (e.g., as described with reference to FIG. 1).

FIG. 2B illustrates an example of person tracking 200-b in a horizontal plane including determined traffic flows to support social distancing guidelines. For example, a system (e.g., a system or device supporting processing of data) may analyze data associated with tracking movements of people within an environment. Based on the analysis, the system may determine one or more directions 215 for traffic within the environment. The determined directions 215 may reduce the number of instances of people failing to adhere to social distancing guidelines. For example, based on the alerts 210 generated in response to person tracking 200-a, the system may determine the directions 215 for traffic flow to reduce the likelihood of alerts 210 in person tracking 200-b.

The system may use stored location information, alert logs, user-defined areas or rules, or some combination thereof to determine the directions 215 for traffic flow. For example, the system may identify common traffic flows, common areas of congestion, or both and may determine to re-route people or common traffic flows based on the identified information. For example, if one doorway is commonly used for both entry into a room and exit from the room, the system may determine new routing information to use the doorway for entry into the room and to use a different doorway for exit from the room. In some cases, the system may additionally display an indication of the location (e.g., the doorway) with a high traffic alert indicator (e.g., to indicate that a number of people greater than a threshold number of people interact at the location). In some examples, a user may define specific boundary thresholds in the environment, areas of importance, areas to avoid, or other features using a user interface. For example, the system may perform specific measurements (e.g., temperature readings) if a person crosses a boundary threshold, enters an area of importance, or enters an area to avoid. Additionally or alternatively, the system may prioritize rerouting people to avoid or provide access to an area of importance. The system may take the user input into account when determining the directions 215 for routing traffic. In some cases, the system may implement a neural network to determine the directions 215, where the neural network may reward outputs in which instances of failed social distancing (e.g., instances of alerts) are reduced. The system may surface the suggested directions 215 for traffic flow to a user in a user interface. In some cases, the user may modify the suggested directions 215. Additionally or alternatively, the system may update the suggested directions 215 based on real-time input of information, changes in historical movement patterns, or the like.

As illustrated, the system may determine a direction 215-a, a direction 215-b, a direction 215-c, and a direction 215-d based on historical tracker 205 information, alerts 210, the physical geometry of the environment, user-defined parameters, or some combination thereof. Directions 215 may be associated with hallways, doorways, stairs, rooms, or any other areas within the environment. In some cases, the system may further track whether the trackers 205 are adhering to the directions 215 for traffic flow. If a tracker 205 does not adhere to the directions 215, the system may trigger an alert 210. As illustrated, a tracker 205-g, a tracker 205-h, a tracker 205-i, a tracker 205-j, a tracker 205-k, and a tracker 205-l may move through the environment according to the determined directions 215 for traffic flow.

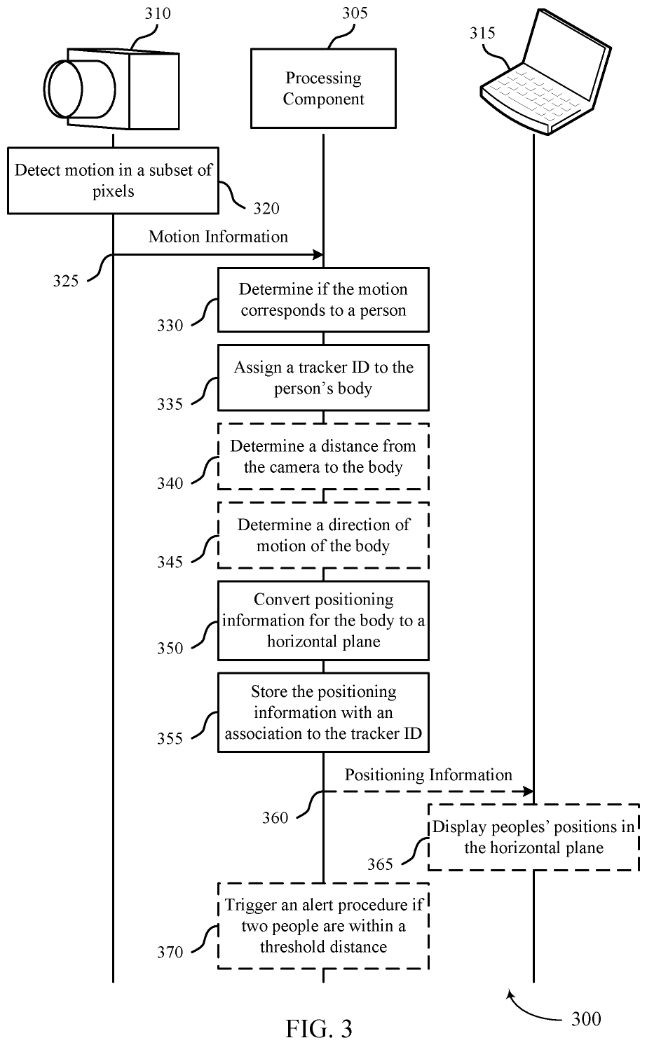

FIG. 3 illustrates an example of a process flow 300 that supports optical person recognition techniques for social distancing in accordance with aspects of the present disclosure. The process flow 300 may be implemented by one or more components of a system 100, as described with reference to FIG. 1. For example, the process flow 300 may include a processing component 305, an optical camera 310, and a user device 315, which may be examples of the corresponding devices described with reference to FIG. 1. In some examples, the processing component 305 may be a components of the optical camera 310, the user device 315, both, or a standalone processing device (e.g., a server, a server cluster, a virtual machine, a user device, or another processing device or system). The optical camera 310, the processing component 305, or both may detect a person and may display positioning information of the person at the user device 315 (e.g., in real-time or in a playback mode). Alternative examples of the following may be implemented, where some steps are performed in a different order than described or are not performed at all. In some cases, steps may include additional features not mentioned below, or further steps may be added.

At 320, the optical camera 310 may detect motion. For example, the view of the optical camera 310 may include a set of pixels. The optical camera 310 may detect motion within a subset of pixels of the set of pixels between different frames. In some examples, the motion may satisfy a threshold difference between frames or sets of frames. Accordingly, the optical camera 310 may mitigate false positives for motion detection in the view of the optical camera 310.

At 325, the optical camera 310 may send information related to the detected motion to a processing component 305 for analysis. For example, the information may include the subset of pixels in which the motion was detected, one or more frames captured by the optical camera 310, or other information. In some cases, the optical camera 310 may perform a compression process to efficiently send the information to the processing component 305.

At 330, the processing component 305 may determine if the motion detected by the optical camera 310 corresponds to a person. For example, the processing component 305 may input the information—or a subset of the information—received at 325 into a trained neural network. The neural network may be trained to identify people, faces, or both, for example, based on a relatively large training set of images, user input, including user verification and feedback, or some combination thereof. The trained neural network may output an indication that at least a portion of the identified subset of pixels corresponds to a body. In some cases, the neural network may support online training, such that the neural network may update based on the input information and the output indication. In some cases, updating the neural network may involve updating one or more weights or functions associated with the nodes of the neural network.

At 335, the processing component 305 may assign, in memory, a tracker ID to the body detected in the optical camera's field of view. The tracker ID may be maintained for the person as the person moves throughout the environment. For example, if a system includes a number of optical cameras 310 connected to a shared processing component 305, memory storage, or both, the system may maintain a tracker ID for a person even as the person moves from the view of one camera to the view of another camera. In some cases, a person may be out of the view of all of the cameras in the system for a time duration. The system may maintain the tracker ID for a time threshold while the person is out of view, and may determine if the person reenters the view of an optical camera 310 based on a prediction of the person's trajectory in the system, a facial recognition technique, a body recognition technique, or any other technique for recognizing the same person exiting and reentering an optical camera's view.

The memory may store a list of tracker IDs and information associated with the tracker IDs. For example, the memory may store one or more screenshots of the detected person, one or more parameters or values associated with the detected person, or any combination thereof. In some cases, if the system supports facial recognition, the memory system may retrieve user-specific information for a detected person based on analyzing the person's face and determining a match in a user database. For example, in an office building, the system may determine the identity of a person entering the building based on one or more images captured by one or more optical cameras 310 and a database of employees for the office building.

At 340, the processing component 305 may determine a distance from the optical camera 310 to the person's body. In some examples, the optical camera 310 may be equipped or otherwise coupled with a stereoscopic sensor. The sensor may detect the distance between the sensor and the person. In some other examples, the processing component 305 may determine the distance based on a size of the person or a part of the person relative to one or more objects in the frame. For example, the processing component 305 may maintain a first bounding box of pixels for a reference object in the view of the optical camera 310 and may store, in memory, one or more measurements associated with the bounding box of pixels (e.g., a measurement for a first dimension, a measurement for a second dimension, a measurement of a distance from the optical camera 310 to the reference object). The optical camera 310, the processing component 305, or both may determine a second bounding box of pixels for the person's body or a portion of the person's body (e.g., the person's face or head). The processing component 305 may determine the distance of the person from the optical camera 310 based on the size of the second bounding box relative to the first bounding box and the measurements stored in memory for the first bounding box.

At 345, the processing component 305 may determine a direction of motion of the body (e.g., based on the motion detected by the optical camera 310). For example, the processing component 305 may input multiple set of pixels corresponding to multiple frames captured by the optical camera 310 into a trained neural network to determine a direction of motion of the person. In some cases, the processing component 305 may store the determined direction of motion of the person in memory (e.g., with an association to the corresponding tracker ID). The processing component 305 may update the stored direction of motion based on the person changing direction, stopping, or both. In some examples, the processing component 305 may use the stored direction of motion to track a person from the view of one optical camera 310 to the view of another optical camera 310. Accordingly, optical cameras 310 in the system may handover trackers such that a person may be tracked throughout a room, building, or other environment.

At 350, the processing component 305 may convert from a first positioning of the body in the view of the optical camera 310 to a second positioning of the body in a horizontal plane. For example, the processing component 305 may use a non-linear matrix calculation to determine the transformation. In some cases, the transformation may be based on the subset of pixels corresponding to the person's body, the determined distance from the optical camera 310, information associated with the person (e.g., a height of the person), or some combination thereof. For example, the optical camera 310 may capture the person's body in a first two-dimensional view (e.g., the view of the camera lens). The processing component 305 may convert the positioning of the person's body in this first two-dimensional view into a three-dimensional view and may further convert the positioning of the person's body into a second two-dimensional view (e.g., a top-down or “bird's-eye” view, such that the processing component 305 determines the person's position in a horizontal plane). In some other examples, the processing component 305 may convert directly from the first two-dimensional view to the second two-dimensional view. In some cases, multiple optical cameras 310 may have a line-of-sight to the same person (e.g., corresponding to the same tracker ID). In some such cases, the processing component 305 may determine multiple positionings for the person in the horizontal plane based on measurements and images from the different optical cameras 310. The processing component 305 may use the multiple determined positionings to calculate a single position for the person in the horizontal plane to store in memory (e.g., an average positioning, a positioning based on one or more weighted values, or the like).

At 355, the processing component 305 may store the positioning information in memory with an association to the tracker ID. The processing component 305 may update the positioning information in real-time (or pseudo-real-time) as the person moves within the view of the camera. In some cases, the processing component 305 may predict a positioning of the person even if the person is outside the view of a camera (e.g., based on previous positioning information, a determined direction of motion for the person's body, or both).

At 360, the processing component 305 may send the positioning information to a user device 315 for display. For example, the processing component 305 may send positioning information for multiple trackers. Additionally or alternatively, the processing component 305 may send information related to the environment, for example, in the horizontal plane (e.g., walls in a room, obstacles in the rooms, locations of doors, locations of stairs, or any other positioning information related to the environment). At 365, the user device 315 may display the positions of the people in the horizontal plane, for examples, as described with reference to FIG. 2. In some cases, the user device 315 may display additional information associated with the people; for example, the user device 315 may display the tracker IDs, user IDs, information associated with the people, proximity information associated with the people, or some combination thereof. In some examples, the user device 315 may display a circle of a specific radius centered around each person in the horizontal plane. The radius may be based on a social distancing threshold, such as a six-foot distance from the person. If another person enters the circle for a first person, the user device 315, the processing component 305, or both may trigger an alert procedure (e.g., at 370). For example, the alert procedure may involve storing an indication of the tracker IDs that were within the social distancing threshold, a duration of time in which they were within the social distancing threshold, or any other information related to the encounter. Additionally or alternatively, the user device 315 may display an alert message, the user device 315 or processing component 305 may send an alert message to another user device (e.g., the phones of the people involved in the encounter), or some combination thereof. Accordingly, the system may identify users failing to comply with social distancing guidelines in real-time and may trigger real-time alerts, store encounter information for future analysis or contact tracing, or both.

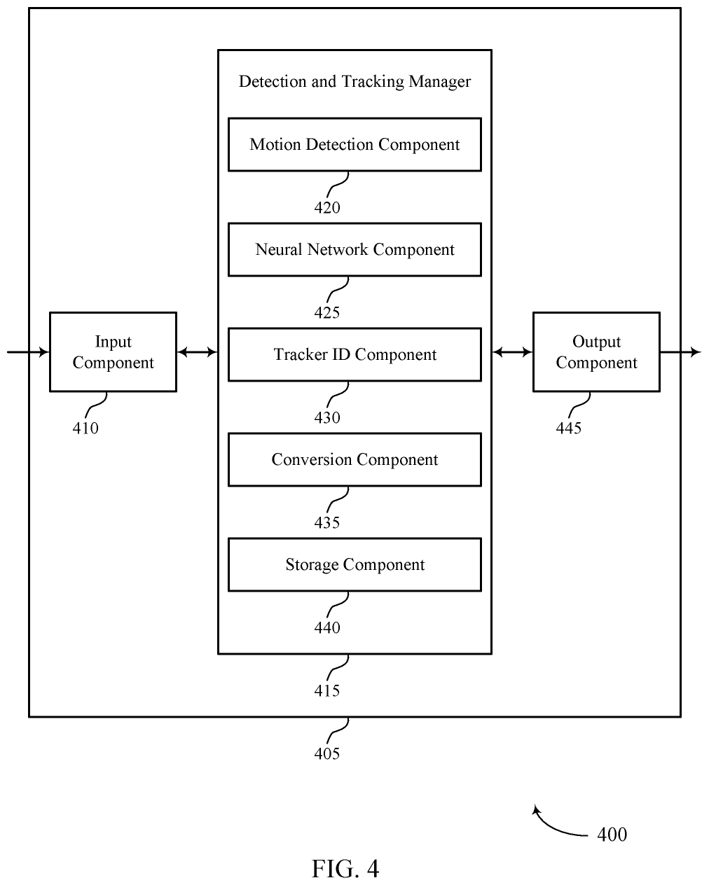

FIG. 4 shows a block diagram 400 of an apparatus 405 that supports optical person recognition techniques for social distancing in accordance with aspects of the present disclosure. The apparatus 405 may include an input component 410, a detection and tracking manager 415, and an output component 445. The apparatus 405 may also include a processor. Each of these components may be in communication with one another (e.g., via one or more buses). In some cases, the apparatus 405 may be an example of a user terminal, a database server, or a system containing multiple computing devices.

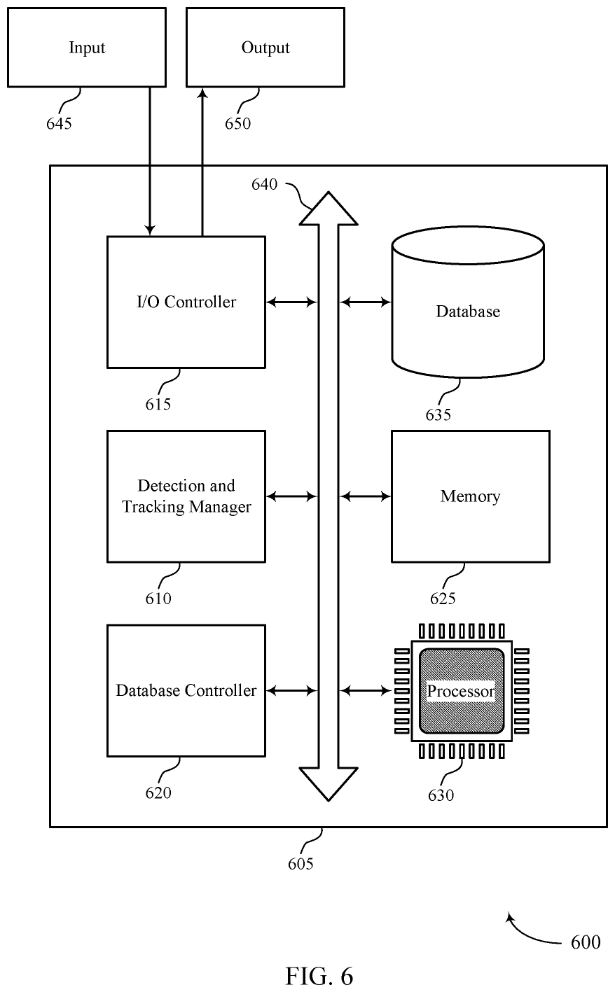

The input component 410 may manage input signals for the apparatus 405. For example, the input component 410 may identify input signals based on an interaction with a modem, a keyboard, a mouse, a touchscreen, or a similar device. These input signals may be associated with user input or processing at other components or devices. In some cases, the input component 410 may utilize an operating system such as iOS®, ANDROID®, MS-DOS®, MS-WINDOWS®, OS/2®, UNIX®, LINUX®, or another known operating system to handle input signals. The input component 410 may send aspects of these input signals to other components of the apparatus 405 for processing. For example, the input component 410 may transmit input signals to the detection and tracking manager 415 to support person detection and tracking. In some cases, the input component 410 may be a component of an input/output (I/O) controller 615 as described with reference to FIG. 6.

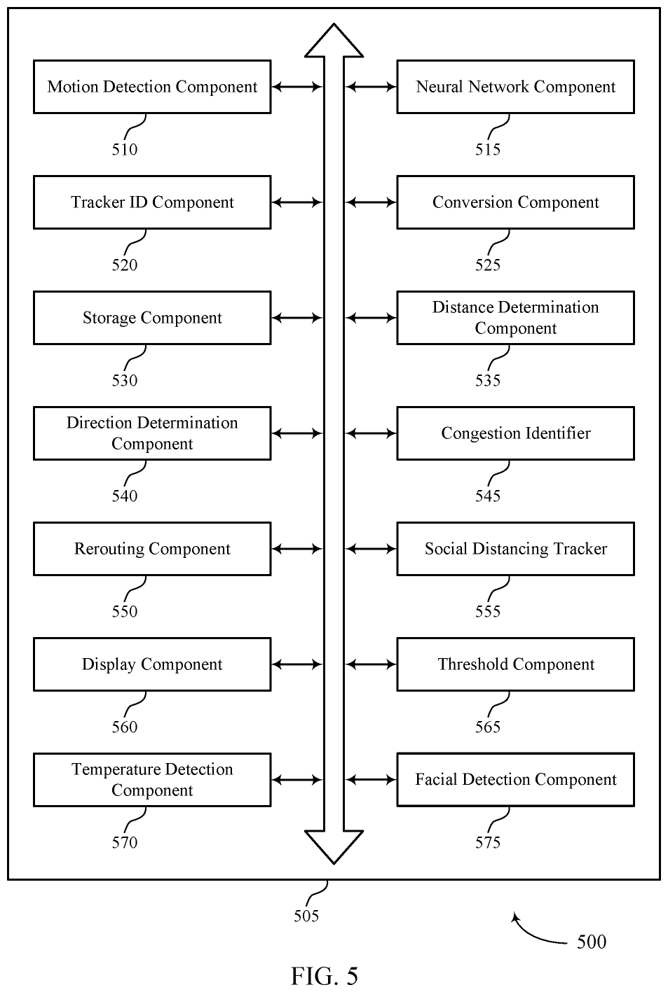

The detection and tracking manager 415 may include a motion detection component 420, a neural network component 425, a tracker ID component 430, a conversion component 435, a storage component 440, or a combination thereof. The detection and tracking manager 415 may be an example of aspects of the detection and tracking manager 505 or 610 described with reference to FIGS. 5 and 6.

The detection and tracking manager 415 and/or at least some of its various sub-components may be implemented in hardware, software executed by a processor, firmware, or any combination thereof. If implemented in software executed by a processor, the functions of the detection and tracking manager 415 and/or at least some of its various sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure. The detection and tracking manager 415 and/or at least some of its various sub-components may be physically located at various positions, including being distributed such that portions of functions are implemented at different physical locations by one or more physical devices. In some examples, the detection and tracking manager 415 and/or at least some of its various sub-components may be a separate and distinct component in accordance with various aspects of the present disclosure. In other examples, the detection and tracking manager 415 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

The motion detection component 420 may detect motion at an optical camera, the motion corresponding to a subset of pixels of a set of pixels for a view of the optical camera. The neural network component 425 may input information corresponding to at least the subset of pixels into a trained neural network and may obtain, as an output of the trained neural network, an indication that at least a portion of the subset of pixels corresponds to a body. The tracker ID component 430 may assign, in memory, a tracker ID to the body. The conversion component 435 may convert from a first positioning of the body in the view of the optical camera to a second positioning of the body in a horizontal plane based on the subset of pixels and a non-linear matrix calculation. The storage component 440 may store, in the memory and with an association to the tracker ID, the second positioning of the body in the horizontal plane.

The output component 445 may manage output signals for the apparatus 405. For example, the output component 445 may receive signals from other components of the apparatus 405, such as the detection and tracking manager 415, and may transmit these signals to other components or devices. In some specific examples, the output component 445 may transmit output signals for display in a user interface, for storage in a database or data store, for further processing at a server or server cluster, or for any other processes at any number of devices or systems. In some cases, the output component 445 may be a component of an I/O controller 615 as described with reference to FIG. 6.

FIG. 5 shows a block diagram 500 of a detection and tracking manager 505 that supports optical person recognition techniques for social distancing in accordance with aspects of the present disclosure. The detection and tracking manager 505 may be an example of aspects of a detection and tracking manager 415 or a detection and tracking manager 610 described herein. The detection and tracking manager 505 may include a motion detection component 510, a neural network component 515, a tracker ID component 520, a conversion component 525, a storage component 530, a distance determination component 535, a direction determination component 540, a congestion identifier 545, a rerouting component 550, a social distancing tracker 555, a display component 560, a threshold component 565, a temperature detection component 570, a facial detection component 575, or any combination of these or other components. Each of these components may communicate, directly or indirectly, with one another (e.g., via one or more buses).

The motion detection component 510 may detect motion at an optical camera, the motion corresponding to a subset of pixels of a set of pixels for a view of the optical camera. The neural network component 515 may input information corresponding to at least the subset of pixels into a trained neural network. The neural network component 515 may obtain, as an output of the trained neural network, an indication that at least a portion of the subset of pixels corresponds to a body. The tracker ID component 520 may assign, in memory, a tracker ID to the body. The conversion component 525 may convert from a first positioning of the body in the view of the optical camera to a second positioning of the body in a horizontal plane based on the subset of pixels and a non-linear matrix calculation. The storage component 530 may store, in the memory and with an association to the tracker ID, the second positioning of the body in the horizontal plane.

The distance determination component 535 may determine a distance from the optical camera to the body, where converting from the first positioning of the body in the view of the optical camera to the second positioning of the body in the horizontal plane is based on the distance. In some cases, the distance is determined based on a first bounding box of pixels for a reference object in the view of the optical camera and a second bounding box of pixels for the body or a portion of the body, where the reference object has a first dimension and a second dimension defined in the memory. In some other cases, the distance is determined by a stereoscopic sensor.

The direction determination component 540 may determine a direction of the motion for the body across a set of frames of the optical camera. In some examples, the storage component 530 may store, in the memory and with a second association to the tracker ID, the direction of the motion for the body.

In some examples, the storage component 530 may dynamically adjust a storage granularity for the tracker ID based on a rate of change for the second positioning of the body in the horizontal plane across the set of frames. In some such examples, the storage component 530 may store, in the memory and with the association to the tracker ID, a set of positions of the body in the horizontal plane according to the storage granularity for the tracker ID, where the storage granularity corresponds to a number of data points that is less than a number of frames in the set of frames.

The congestion identifier 545 may determine a location in the horizontal plane associated with a number of bodies greater than a threshold number of bodies based on the stored second positioning of the body in the horizontal plane, the stored direction of the motion for the body, or both. In some examples, the congestion identifier 545 may send, for display in a user interface, an indication of the location with a high traffic alert indicator.

The rerouting component 550 may determine a rerouting suggestion for the horizontal plane based on the location and the high traffic alert indicator.

The social distancing tracker 555 may generate a circle of a specific radius centered around the body in the horizontal plane. In some examples, the social distancing tracker 555 may determine if a positioning of a second body corresponding to a second tracker ID in the horizontal plane is within the generated circle for the body. In some examples, the social distancing tracker 555 may trigger an alert procedure based on the positioning of the second body being within the generated circle for the body.

The display component 560 may send, for display in a user interface, the second positioning of the body in the horizontal plane and the generated circle for the body.

In some examples, the display component 560 may send, for display in a user interface, the view of the optical camera. The threshold component 565 may receive, from the user interface, a user input indicating an area of importance, a boundary threshold, or both in the view of the optical camera. In some examples, the threshold component 565 may trigger an action based on the body being within the area of importance, the body crossing the boundary threshold, or both.

The temperature detection component 570 may perform a temperature reading on at least a portion of the body using a thermal sensor aligned with the optical camera.

The facial detection component 575 may input second information corresponding to at least a second subset of the subset of pixels into a second trained neural network, where the second subset of the subset of pixels is based on a portion of the body. In some examples, the facial detection component 575 may obtain, as a second output of the second trained neural network, a second indication that at least a portion of the second subset of the subset of pixels corresponds to a face.

In some examples, the facial detection component 575 may classify one or more features of the face based on one or more additional neural networks, where the one or more features of the face include whether the face is wearing a mask, whether the face is wearing glasses, whether the face is wearing a hat, whether the face corresponds to a known face stored in the memory, or a combination thereof.

FIG. 6 shows a diagram of a system 600 including a device 605 that supports optical person recognition techniques for social distancing in accordance with aspects of the present disclosure. The device 605 may be an example of or include the components of a processing component or an apparatus 405 as described herein. The processing component may be an example of a camera, a sensor, a user device, a server (e.g., an application server, a database server, a cloud-based server, a worker server, a server cluster, a virtual machine, a container, or any combination of these or other devices or systems supporting data processing), or any combination thereof. The device 605 may include components for bi-directional data communications including components for transmitting and receiving communications, including a detection and tracking manager 610, an I/O controller 615, a database controller 620, memory 625, a processor 630, and a database 635. These components may be in electronic communication via one or more buses (e.g., bus 640).

The detection and tracking manager 610 may be an example of a detection and tracking manager 415 or 505 as described herein. For example, the detection and tracking manager 610 may perform any of the methods or processes described above with reference to FIGS. 4 and 5. In some cases, the detection and tracking manager 610 may be implemented in hardware, software executed by a processor, firmware, or any combination thereof.

The I/O controller 615 may manage input signals 645 and output signals 650 for the device 605. The I/O controller 615 may also manage peripherals not integrated into the device 605. In some cases, the I/O controller 615 may represent a physical connection or port to an external peripheral. In some cases, the I/O controller 615 may utilize an operating system such as iOS®, ANDROID®, MS-DOS®, MS-WINDOWS®, OS/2®, UNIX®, LINUX®, or another known operating system. In other cases, the I/O controller 615 may represent or interact with a modem, a keyboard, a mouse, a touchscreen, or a similar device. In some cases, the I/O controller 615 may be implemented as part of a processor. In some cases, a user may interact with the device 605 via the I/O controller 615 or via hardware components controlled by the I/O controller 615.

The database controller 620 may manage data storage and processing in a database 635. In some cases, a user may interact with the database controller 620. In other cases, the database controller 620 may operate automatically without user interaction. The database 635 may be an example of a single database, a distributed database, multiple distributed databases, a data store, a data lake, or an emergency backup database.

Memory 625 may include random-access memory (RAM) and read-only memory (ROM). The memory 625 may store computer-readable, computer-executable software including instructions that, when executed, cause the processor to perform various functions described herein. In some cases, the memory 625 may contain, among other things, a basic input/output system (BIOS) which may control basic hardware or software operation such as the interaction with peripheral components or devices.

The processor 630 may include an intelligent hardware device (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 630 may be configured to operate a memory array using a memory controller. In other cases, a memory controller may be integrated into the processor 630. The processor 630 may be configured to execute computer-readable instructions stored in a memory 625 to perform various functions (e.g., functions or tasks supporting optical person recognition techniques for social distancing).

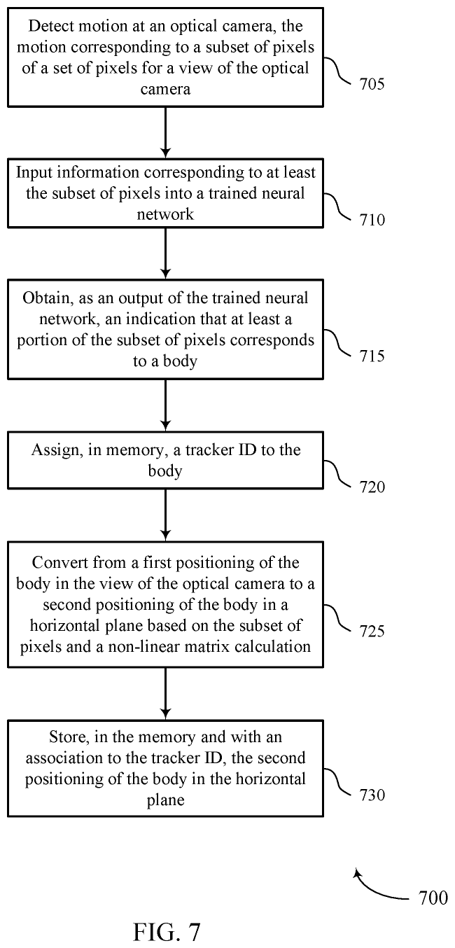

FIG. 7 shows a flowchart illustrating a method 700 that supports optical person recognition techniques for social distancing in accordance with aspects of the present disclosure. The operations of method 700 may be implemented by a processing component or other components as described herein. For example, the operations of method 700 may be performed by a detection and tracking manager as described with reference to FIGS. 4 through 6. The processing component may be an example of a camera, a sensor, a user device, a server (e.g., an application server, a database server, a cloud-based server, a worker server, a server cluster, a virtual machine, a container, or any combination of these or other devices or systems supporting data processing), or any combination thereof. In some examples, the processing component may execute a set of instructions to control the functional elements of the application server to perform the functions described below. Additionally or alternatively, the processing component may perform aspects of the functions described below using special-purpose hardware.

At 705, the processing component may detect motion at an optical camera, the motion corresponding to a subset of pixels of a set of pixels for a view of the optical camera. The operations of 705 may be performed according to the methods described herein. In some examples, aspects of the operations of 705 may be performed by a motion detection component as described with reference to FIGS. 4 through 6.

At 710, the processing component may input information corresponding to at least the subset of pixels into a trained neural network. The operations of 710 may be performed according to the methods described herein. In some examples, aspects of the operations of 710 may be performed by a neural network component as described with reference to FIGS. 4 through 6.

At 715, the processing component may obtain, as an output of the trained neural network, an indication that at least a portion of the subset of pixels corresponds to a body. The operations of 715 may be performed according to the methods described herein. In some examples, aspects of the operations of 715 may be performed by a neural network component as described with reference to FIGS. 4 through 6.

At 720, the processing component may assign, in memory, a tracker ID to the body. The operations of 720 may be performed according to the methods described herein. In some examples, aspects of the operations of 720 may be performed by a tracker ID component as described with reference to FIGS. 4 through 6.

At 725, the processing component may convert from a first positioning of the body in the view of the optical camera to a second positioning of the body in a horizontal plane based on the subset of pixels and a non-linear matrix calculation. The operations of 725 may be performed according to the methods described herein. In some examples, aspects of the operations of 725 may be performed by a conversion component as described with reference to FIGS. 4 through 6.

At 730, the processing component may store, in the memory and with an association to the tracker ID, the second positioning of the body in the horizontal plane. The operations of 730 may be performed according to the methods described herein. In some examples, aspects of the operations of 730 may be performed by a storage component as described with reference to FIGS. 4 through 6.

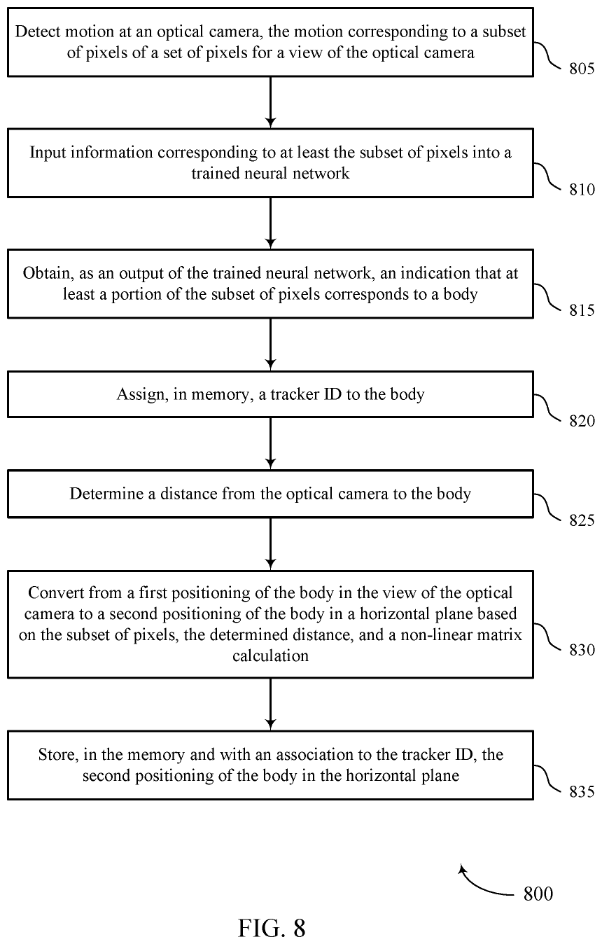

FIG. 8 shows a flowchart illustrating a method 800 that supports optical person recognition techniques for social distancing in accordance with aspects of the present disclosure. The operations of method 800 may be implemented by a processing component or other components as described herein. For example, the operations of method 800 may be performed by a detection and tracking manager as described with reference to FIGS. 4 through 6. In some examples, a processing component may execute a set of instructions to control the functional elements of the application server to perform the functions described below. Additionally or alternatively, a processing component may perform aspects of the functions described below using special-purpose hardware.

At 805, the processing component may detect motion at an optical camera, the motion corresponding to a subset of pixels of a set of pixels for a view of the optical camera. The operations of 805 may be performed according to the methods described herein. In some examples, aspects of the operations of 805 may be performed by a motion detection component as described with reference to FIGS. 4 through 6.

At 810, the processing component may input information corresponding to at least the subset of pixels into a trained neural network. The operations of 810 may be performed according to the methods described herein. In some examples, aspects of the operations of 810 may be performed by a neural network component as described with reference to FIGS. 4 through 6.

At 815, the processing component may obtain, as an output of the trained neural network, an indication that at least a portion of the subset of pixels corresponds to a body. The operations of 815 may be performed according to the methods described herein. In some examples, aspects of the operations of 815 may be performed by a neural network component as described with reference to FIGS. 4 through 6.

At 820, the processing component may assign, in memory, a tracker ID to the body. The operations of 820 may be performed according to the methods described herein. In some examples, aspects of the operations of 820 may be performed by a tracker ID component as described with reference to FIGS. 4 through 6.

At 825, the processing component may determine a distance from the optical camera to the body. The operations of 825 may be performed according to the methods described herein. In some examples, aspects of the operations of 825 may be performed by a distance determination component as described with reference to FIGS. 4 through 6.

At 830, the processing component may convert from a first positioning of the body in the view of the optical camera to a second positioning of the body in a horizontal plane based on the subset of pixels, the determined distance, and a non-linear matrix calculation. The operations of 830 may be performed according to the methods described herein. In some examples, aspects of the operations of 830 may be performed by a conversion component as described with reference to FIGS. 4 through 6.

At 835, the processing component may store, in the memory and with an association to the tracker ID, the second positioning of the body in the horizontal plane. The operations of 835 may be performed according to the methods described herein. In some examples, aspects of the operations of 835 may be performed by a storage component as described with reference to FIGS. 4 through 6.

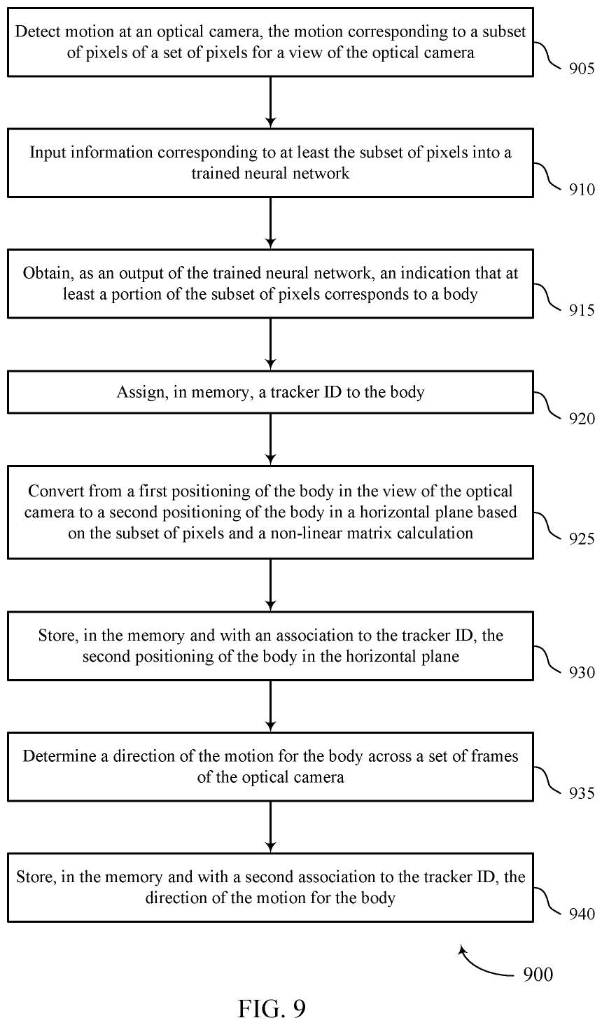

FIG. 9 shows a flowchart illustrating a method 900 that supports optical person recognition techniques for social distancing in accordance with aspects of the present disclosure. The operations of method 900 may be implemented by a processing component or other components as described herein. For example, the operations of method 900 may be performed by a detection and tracking manager as described with reference to FIGS. 4 through 6. In some examples, a processing component may execute a set of instructions to control the functional elements of the application server to perform the functions described below. Additionally or alternatively, a processing component may perform aspects of the functions described below using special-purpose hardware.

At 905, the processing component may detect motion at an optical camera, the motion corresponding to a subset of pixels of a set of pixels for a view of the optical camera. The operations of 905 may be performed according to the methods described herein. In some examples, aspects of the operations of 905 may be performed by a motion detection component as described with reference to FIGS. 4 through 6.

At 910, the processing component may input information corresponding to at least the subset of pixels into a trained neural network. The operations of 910 may be performed according to the methods described herein. In some examples, aspects of the operations of 910 may be performed by a neural network component as described with reference to FIGS. 4 through 6.

At 915, the processing component may obtain, as an output of the trained neural network, an indication that at least a portion of the subset of pixels corresponds to a body. The operations of 915 may be performed according to the methods described herein. In some examples, aspects of the operations of 915 may be performed by a neural network component as described with reference to FIGS. 4 through 6.

At 920, the processing component may assign, in memory, a tracker ID to the body. The operations of 920 may be performed according to the methods described herein. In some examples, aspects of the operations of 920 may be performed by a tracker ID component as described with reference to FIGS. 4 through 6.

At 925, the processing component may convert from a first positioning of the body in the view of the optical camera to a second positioning of the body in a horizontal plane based on the subset of pixels and a non-linear matrix calculation. The operations of 925 may be performed according to the methods described herein. In some examples, aspects of the operations of 925 may be performed by a conversion component as described with reference to FIGS. 4 through 6.

At 930, the processing component may store, in the memory and with an association to the tracker ID, the second positioning of the body in the horizontal plane. The operations of 930 may be performed according to the methods described herein. In some examples, aspects of the operations of 930 may be performed by a storage component as described with reference to FIGS. 4 through 6.

At 935, the processing component may determine a direction of the motion for the body across a set of frames of the optical camera. The operations of 935 may be performed according to the methods described herein. In some examples, aspects of the operations of 935 may be performed by a direction determination component as described with reference to FIGS. 4 through 6.

At 940, the processing component may store, in the memory and with a second association to the tracker ID, the direction of the motion for the body. The operations of 940 may be performed according to the methods described herein. In some examples, aspects of the operations of 940 may be performed by a storage component as described with reference to FIGS. 4 through 6.

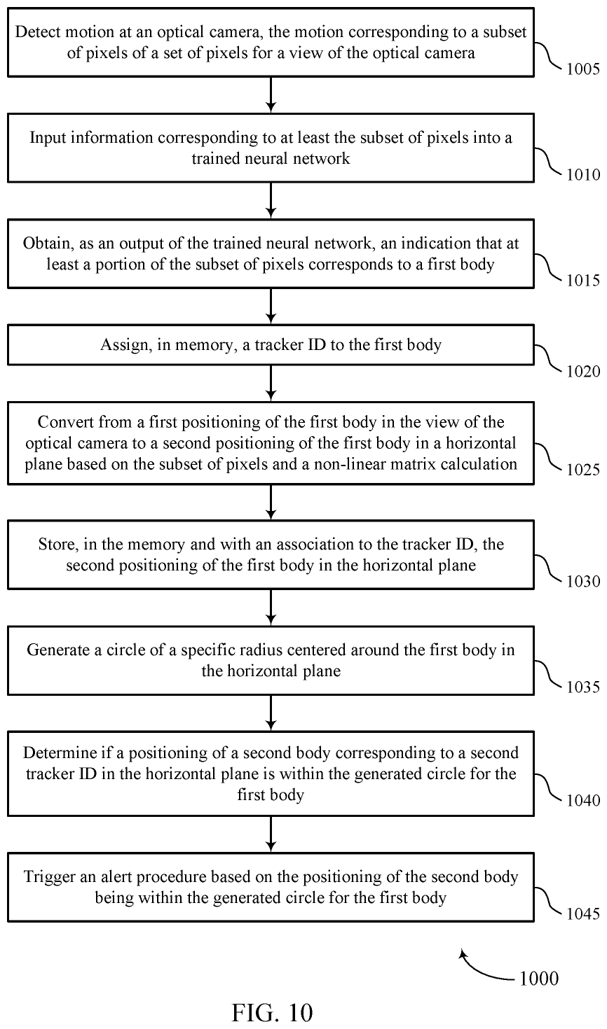

FIG. 10 shows a flowchart illustrating a method 1000 that supports optical person recognition techniques for social distancing in accordance with aspects of the present disclosure. The operations of method 1000 may be implemented by a processing component or other components as described herein. For example, the operations of method 1000 may be performed by a detection and tracking manager as described with reference to FIGS. 4 through 6. In some examples, a processing component may execute a set of instructions to control the functional elements of the application server to perform the functions described below. Additionally or alternatively, a processing component may perform aspects of the functions described below using special-purpose hardware.

At 1005, the processing component may detect motion at an optical camera, the motion corresponding to a subset of pixels of a set of pixels for a view of the optical camera. The operations of 1005 may be performed according to the methods described herein. In some examples, aspects of the operations of 1005 may be performed by a motion detection component as described with reference to FIGS. 4 through 6.

At 1010, the processing component may input information corresponding to at least the subset of pixels into a trained neural network. The operations of 1010 may be performed according to the methods described herein. In some examples, aspects of the operations of 1010 may be performed by a neural network component as described with reference to FIGS. 4 through 6.

At 1015, the processing component may obtain, as an output of the trained neural network, an indication that at least a portion of the subset of pixels corresponds to a body. The operations of 1015 may be performed according to the methods described herein. In some examples, aspects of the operations of 1015 may be performed by a neural network component as described with reference to FIGS. 4 through 6.

At 1020, the processing component may assign, in memory, a tracker ID to the body. The operations of 1020 may be performed according to the methods described herein. In some examples, aspects of the operations of 1020 may be performed by a tracker ID component as described with reference to FIGS. 4 through 6.

At 1025, the processing component may convert from a first positioning of the body in the view of the optical camera to a second positioning of the body in a horizontal plane based on the subset of pixels and a non-linear matrix calculation. The operations of 1025 may be performed according to the methods described herein. In some examples, aspects of the operations of 1025 may be performed by a conversion component as described with reference to FIGS. 4 through 6.

At 1030, the processing component may store, in the memory and with an association to the tracker ID, the second positioning of the body in the horizontal plane. The operations of 1030 may be performed according to the methods described herein. In some examples, aspects of the operations of 1030 may be performed by a storage component as described with reference to FIGS. 4 through 6.

At 1035, the processing component may generate a circle of a specific radius centered around the body in the horizontal plane. The operations of 1035 may be performed according to the methods described herein. In some examples, aspects of the operations of 1035 may be performed by a social distancing tracker as described with reference to FIGS. 4 through 6.

At 1040, the processing component may determine if a positioning of a second body corresponding to a second tracker ID in the horizontal plane is within the generated circle for the body. The operations of 1040 may be performed according to the methods described herein. In some examples, aspects of the operations of 1040 may be performed by a social distancing tracker as described with reference to FIGS. 4 through 6.

At 1045, the processing component may trigger an alert procedure based on the positioning of the second body being within the generated circle for the body. The operations of 1045 may be performed according to the methods described herein. In some examples, aspects of the operations of 1045 may be performed by a social distancing tracker as described with reference to FIGS. 4 through 6.

A method for person detection and tracking is described. The method may include detecting motion at an optical camera, the motion corresponding to a subset of pixels of a set of pixels for a view of the optical camera, inputting information corresponding to at least the subset of pixels into a trained neural network, obtaining, as an output of the trained neural network, an indication that at least a portion of the subset of pixels corresponds to a body, assigning, in memory, a tracker ID to the body, converting from a first positioning of the body in the view of the optical camera to a second positioning of the body in a horizontal plane based on the subset of pixels and a non-linear matrix calculation, and storing, in the memory and with an association to the tracker ID, the second positioning of the body in the horizontal plane.

An apparatus for person detection and tracking is described. The apparatus may include a processor, memory coupled with the processor, and instructions stored in the memory. The instructions may be executable by the processor to cause the apparatus to detect motion at an optical camera, the motion corresponding to a subset of pixels of a set of pixels for a view of the optical camera, input information corresponding to at least the subset of pixels into a trained neural network, obtain, as an output of the trained neural network, an indication that at least a portion of the subset of pixels corresponds to a body, assign, in the memory, a tracker ID to the body, convert from a first positioning of the body in the view of the optical camera to a second positioning of the body in a horizontal plane based on the subset of pixels and a non-linear matrix calculation, and store, in the memory and with an association to the tracker ID, the second positioning of the body in the horizontal plane.

Another apparatus for person detection and tracking is described. The apparatus may include means for detecting motion at an optical camera, the motion corresponding to a subset of pixels of a set of pixels for a view of the optical camera, inputting information corresponding to at least the subset of pixels into a trained neural network, obtaining, as an output of the trained neural network, an indication that at least a portion of the subset of pixels corresponds to a body, assigning, in memory, a tracker ID to the body, converting from a first positioning of the body in the view of the optical camera to a second positioning of the body in a horizontal plane based on the subset of pixels and a non-linear matrix calculation, and storing, in the memory and with an association to the tracker ID, the second positioning of the body in the horizontal plane.

A non-transitory computer-readable medium storing code for person detection and tracking is described. The code may include instructions executable by a processor to detect motion at an optical camera, the motion corresponding to a subset of pixels of a set of pixels for a view of the optical camera, input information corresponding to at least the subset of pixels into a trained neural network, obtain, as an output of the trained neural network, an indication that at least a portion of the subset of pixels corresponds to a body, assign, in memory, a tracker ID to the body, convert from a first positioning of the body in the view of the optical camera to a second positioning of the body in a horizontal plane based on the subset of pixels and a non-linear matrix calculation, and store, in the memory and with an association to the tracker ID, the second positioning of the body in the horizontal plane.

Some examples of the method, apparatuses, and non-transitory computer-readable medium described herein may further include operations, features, means, or instructions for determining a distance from the optical camera to the body, where converting from the first positioning of the body in the view of the optical camera to the second positioning of the body in the horizontal plane may be based on the distance.

In some examples of the method, apparatuses, and non-transitory computer-readable medium described herein, the distance may be determined based on a first bounding box of pixels for a reference object in the view of the optical camera and a second bounding box of pixels for the body or a portion of the body, where the reference object may have a first dimension and a second dimension defined in the memory.

In some examples of the method, apparatuses, and non-transitory computer-readable medium described herein, the distance may be determined by a stereoscopic sensor.

Some examples of the method, apparatuses, and non-transitory computer-readable medium described herein may further include operations, features, means, or instructions for determining a direction of the motion for the body across a set of frames of the optical camera and storing, in the memory and with a second association to the tracker ID, the direction of the motion for the body.

Some examples of the method, apparatuses, and non-transitory computer-readable medium described herein may further include operations, features, means, or instructions for dynamically adjusting a storage granularity for the tracker ID based on a rate of change for the second positioning of the body in the horizontal plane across the set of frames and storing, in the memory and with the association to the tracker ID, a set of positions of the body in the horizontal plane according to the storage granularity for the tracker ID, where the storage granularity corresponds to a number of data points that may be less than a number of frames in the set of frames.

Some examples of the method, apparatuses, and non-transitory computer-readable medium described herein may further include operations, features, means, or instructions for determining a location in the horizontal plane associated with a number of bodies greater than a threshold number of bodies based on the stored second positioning of the body in the horizontal plane, the stored direction of the motion for the body, or both, and sending, for display in a user interface, an indication of the location with a high traffic alert indicator.

Some examples of the method, apparatuses, and non-transitory computer-readable medium described herein may further include operations, features, means, or instructions for determining a rerouting suggestion for the horizontal plane based on the location and the high traffic alert indicator.

Some examples of the method, apparatuses, and non-transitory computer-readable medium described herein may further include operations, features, means, or instructions for generating a circle of a specific radius centered around the body in the horizontal plane and determining if a positioning of a second body corresponding to a second tracker ID in the horizontal plane may be within the generated circle for the body.

Some examples of the method, apparatuses, and non-transitory computer-readable medium described herein may further include operations, features, means, or instructions for triggering an alert procedure based on the positioning of the second body being within the generated circle for the body.

Some examples of the method, apparatuses, and non-transitory computer-readable medium described herein may further include operations, features, means, or instructions for sending, for display in a user interface, the second positioning of the body in the horizontal plane and the generated circle for the body.

Some examples of the method, apparatuses, and non-transitory computer-readable medium described herein may further include operations, features, means, or instructions for sending, for display in a user interface, the view of the optical camera, receiving, from the user interface, a user input indicating an area of importance, a boundary threshold, or both in the view of the optical camera, and triggering an action based on the body being within the area of importance, the body crossing the boundary threshold, or both.

In some examples of the method, apparatuses, and non-transitory computer-readable medium described herein, triggering the action may include operations, features, means, or instructions for performing a temperature reading on at least a portion of the body using a thermal sensor aligned with the optical camera.

Some examples of the method, apparatuses, and non-transitory computer-readable medium described herein may further include operations, features, means, or instructions for inputting second information corresponding to at least a second subset of the subset of pixels into a second trained neural network, where the second subset of the subset of pixels may be based on a portion of the body, and obtaining, as a second output of the second trained neural network, a second indication that at least a portion of the second subset of the subset of pixels corresponds to a face.

Some examples of the method, apparatuses, and non-transitory computer-readable medium described herein may further include operations, features, means, or instructions for classifying one or more features of the face based on one or more additional neural networks, where the one or more features of the face include whether the face is wearing a mask, whether the face is wearing glasses, whether the face is wearing a hat, whether the face corresponds to a known face stored in the memory, or a combination thereof.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for person detection and tracking, comprising:
detecting motion at an optical camera, the motion corresponding to a subset of pixels of a set of pixels for a view of the optical camera;
inputting information corresponding to at least the subset of pixels into a trained neural network;
obtaining, as an output of the trained neural network, an indication that at least a portion of the subset of pixels corresponds to a body;
assigning, in memory, a tracker identifier to the body;
converting from a first positioning of the body in the view of the optical camera to a second positioning of the body in a horizontal plane based at least in part on the subset of pixels and a non-linear matrix calculation; and
storing, in the memory and with an association to the tracker identifier, the second positioning of the body in the horizontal plane.

2. The method of claim 1, further comprising:
determining a distance from the optical camera to the body, wherein converting from the first positioning of the body in the view of the optical camera to the second positioning of the body in the horizontal plane is based at least in part on the distance.

3. The method of claim 2, wherein the distance is determined based at least in part on a first bounding box of pixels for a reference object in the view of the optical camera and a second bounding box of pixels for the body or a portion of the body, wherein the reference object has a first dimension and a second dimension defined in the memory.

4. The method of claim 2, wherein the distance is determined by a stereoscopic sensor.

5. The method of claim 1, further comprising:
determining a direction of the motion for the body across a plurality of frames of the optical camera; and
storing, in the memory and with a second association to the tracker identifier, the direction of the motion for the body.

6. The method of claim 5, further comprising:
dynamically adjusting a storage granularity for the tracker identifier based at least in part on a rate of change for the second positioning of the body in the horizontal plane across the plurality of frames; and
storing, in the memory and with the association to the tracker identifier, a plurality of positions of the body in the horizontal plane according to the storage granularity for the tracker identifier, wherein the storage granularity corresponds to a number of data points that is less than a number of frames in the plurality of frames.

7. The method of claim 5, further comprising:
determining a location in the horizontal plane associated with a number of bodies greater than a threshold number of bodies based at least in part on the stored second positioning of the body in the horizontal plane, the stored direction of the motion for the body, or both; and
sending, for display in a user interface, an indication of the location with a high traffic alert indicator.

8. The method of claim 7, further comprising:
determining a rerouting suggestion for the horizontal plane based at least in part on the location and the high traffic alert indicator.

9. The method of claim 1, further comprising:
generating a circle of a specific radius centered around the body in the horizontal plane; and
determining if a positioning of a second body corresponding to a second tracker identifier in the horizontal plane is within the generated circle for the body.

10. The method of claim 9, further comprising:
triggering an alert procedure based at least in part on the positioning of the second body being within the generated circle for the body.

11. The method of claim 9, further comprising:
sending, for display in a user interface, the second positioning of the body in the horizontal plane and the generated circle for the body.

12. The method of claim 1, further comprising:
sending, for display in a user interface, the view of the optical camera;
receiving, from the user interface, a user input indicating an area of importance, a boundary threshold, or both in the view of the optical camera; and
triggering an action based at least in part on the body being within the area of importance, the body crossing the boundary threshold, or both.

13. The method of claim 12, wherein triggering the action comprises:
performing a temperature reading on at least a portion of the body using a thermal sensor aligned with the optical camera.

14. The method of claim 1, further comprising:
inputting second information corresponding to at least a second subset of the subset of pixels into a second trained neural network, wherein the second subset of the subset of pixels is based at least in part on a portion of the body; and
obtaining, as a second output of the second trained neural network, a second indication that at least a portion of the second subset of the subset of pixels corresponds to a face.

15. The method of claim 14, further comprising:
classifying one or more features of the face based at least in part on one or more additional neural networks, wherein the one or more features of the face comprise whether the face is wearing a mask, whether the face is wearing glasses, whether the face is wearing a hat, whether the face corresponds to a known face stored in the memory, or a combination thereof.

16. An apparatus for person detection and tracking, comprising:
a processor;
memory coupled with the processor; and
instructions stored in the memory and executable by the processor to cause the apparatus to:
detect motion at an optical camera, the motion corresponding to a subset of pixels of a set of pixels for a view of the optical camera;
input information corresponding to at least the subset of pixels into a trained neural network;
obtain, as an output of the trained neural network, an indication that at least a portion of the subset of pixels corresponds to a body;
assign, in the memory, a tracker identifier to the body;
convert from a first positioning of the body in the view of the optical camera to a second positioning of the body in a horizontal plane based at least in part on the subset of pixels and a non-linear matrix calculation; and
store, in the memory and with an association to the tracker identifier, the second positioning of the body in the horizontal plane.

17. The apparatus of claim 16, wherein the instructions are further executable by the processor to cause the apparatus to:
determine a distance from the optical camera to the body, wherein converting from the first positioning of the body in the view of the optical camera to the second positioning of the body in the horizontal plane is based at least in part on the distance.

18. The apparatus of claim 16, wherein the instructions are further executable by the processor to cause the apparatus to:
determine a direction of the motion for the body across a plurality of frames of the optical camera; and
store, in the memory and with a second association to the tracker identifier, the direction of the motion for the body.

19. The apparatus of claim 18, wherein the instructions are further executable by the processor to cause the apparatus to:
dynamically adjust a storage granularity for the tracker identifier based at least in part on a rate of change for the second positioning of the body in the horizontal plane across the plurality of frames; and
store, in the memory and with the association to the tracker identifier, a plurality of positions of the body in the horizontal plane according to the storage granularity for the tracker identifier, wherein the storage granularity corresponds to a number of data points that is less than a number of frames in the plurality of frames.

20. A non-transitory computer-readable medium storing code for person detection and tracking, the code comprising instructions executable by a processor to:
detect motion at an optical camera, the motion corresponding to a subset of pixels of a set of pixels for a view of the optical camera;
input information corresponding to at least the subset of pixels into a trained neural network;
obtain, as an output of the trained neural network, an indication that at least a portion of the subset of pixels corresponds to a body;
assign, in memory, a tracker identifier to the body;
convert from a first positioning of the body in the view of the optical camera to a second positioning of the body in a horizontal plane based at least in part on the subset of pixels and a non-linear matrix calculation; and
store, in the memory and with an association to the tracker identifier, the second positioning of the body in the horizontal plane.
